(19) United States
(12) Patent Application Publication
(10) Pub. No.: US 2026/0182770 A1
(43) Pub. Date: Jul. 2, 2026

(54) CONTROL METHOD FOR FOOD COOKING BASED ON MULTI-POINT DETECTION, ELECTRONIC DEVICE, AND STORAGE MEDIUM

(71) Applicant: SHENZHEN YINGBOWEIYE TECHNOLOGY CO., LTD, Shenzhen (CN)

(72) Inventors: Jingru Xie, Shenzhen (CN); Jinghua Xie, Shenzhen (CN); Qianyu Zhao, Shenzhen (CN)

(21) Appl. No.: 19/026,861

(22) Filed: Jan. 17, 2025

(30) Foreign Application Priority Data
Jan. 2, 2025 (CN) 202510011981.8

(51) Int. Cl. A47J 36/32

(52) U.S. Cl. CPC A47J 36/32

(57) ABSTRACT

A control method for food cooking based on multi-point detection, an electronic device and a storage medium are provided. The method determines a plurality of temperature detection points on food, with a food thermometer inserted into each temperature detection point; and triggers each food thermometer to detect a real-time temperature of food, and records detection temperatures corresponding to the plurality of temperature detection points. A plurality of temperature change curves are obtained by generating a temperature change curve based on detection temperatures of each temperature detection point. A temperature distribution graph of food is generated based on the plurality of temperature change curves and a type of the food. Remaining cooking time of food is calculated according to the temperature distribution graph of food. A cooking instruction is generated to dynamically control the cooking instruction, according to the remaining cooking time of food.

### CROSS REFERENCE TO RELATED APPLICATIONS

The present application claims the benefit of Chinese Patent Application No. 202510011981.8 filed on Jan. 2, 2025, the contents of which are incorporated herein by reference in their entirety.

### TECHNICAL FIELD

The present disclosure relates to the technical field of food thermometers, in particular to a control method for food cooking based on multi-point detection, and an electronic device.

### BACKGROUND

With a development of science and technology, food thermometers are applied to people's lives and detect a temperature of food. At this time, the food thermometer is inserted into food to detect the temperature of the food, so as to record the temperature of the food and estimate corresponding remaining cooking time. However, the existing food thermometer determines the overall temperature of food by detecting the temperature at a single time or at a single position, which cannot guarantee an accuracy of a temperature distribution graph and further affects the temperature control of the food thermometer for food and intelligent cooking of food.

### SUMMARY

The present disclosure aims to overcome the disadvantages in the prior art. The present disclosure provides a control method for food cooking based on multi-point detection and an electronic device.

A plurality of temperature detection points of the food thermometer relative to food are collected. Real-time temperature detecting of food is triggered based on a plurality of temperature detection points, and detection temperatures corresponding to a plurality of temperature detection points are recorded. A temperature change curve of each temperature detection point is defined based on a detection temperature of each temperature detection point. A temperature distribution graph of food is constructed based on a plurality of temperature change curves and the type of food. By comprehensively considering the plurality of temperature change curves and the type of food, multi-dimensional control for a plurality of temperature change curves and the type of food is realized, and the accuracy of the temperature distribution graph is ensured.

Further, the remaining cooking time of food is measured and calculated according to the temperature distribution graph of food. The cooking control logic of food is triggered according to the remaining cooking time of food, and a cooking instruction of each part in food is dynamically controlled based on the cooking control logic. The temperature distribution graph of food is fully utilized for cooking control, so that the remaining cooking time of food is measured and calculated, the accuracy of the remaining cooking time of food is ensured, and the temperature control of the food thermometer for food and intelligent cooking of food are realized.

In the embodiments of the present disclosure, through the method in the embodiments of the present disclosure, a plurality of temperature detection points of the food thermometer relative to food are collected. Real-time temperature detecting of food is triggered based on a plurality of temperature detection points, and detection temperatures corresponding to a plurality of temperature detection points are recorded. A temperature change curve of each temperature detection point is defined based on a detection temperature of each temperature detection point. A temperature distribution graph of food is constructed based on a plurality of temperature change curves and the type of food. By comprehensively considering the plurality of temperature change curves and the type of food, multi-dimensional control for a plurality of temperature change curves and the type of food is realized, and the accuracy of the temperature distribution graph is ensured.

Further, the remaining cooking time of food is measured and calculated according to the temperature distribution graph of food. The cooking control logic of food is triggered according to the remaining cooking time of food, and a cooking instruction of each part in food is dynamically controlled based on the cooking control logic. The temperature distribution graph of food is fully utilized for cooking control, so that the remaining cooking time of food is measured and calculated, the accuracy of the remaining cooking time of food is ensured, and the temperature control of the food thermometer for food and intelligent cooking of food are realized.

### BRIEF DESCRIPTION OF THE DRAWINGS

To describe the technical solutions in the embodiments of the present disclosure or in the prior art more clearly, the following briefly describes the attached figures required for describing the embodiments or the prior art. Apparently, the attached figures in the following description show merely some embodiments of the present disclosure, and a person of ordinary skill in the art may derive other drawings from these attached figures without creative efforts.

FIG. 1 is a schematic flow chart of a control method for food cooking based on multi-point detection according to an embodiment of the present disclosure.

FIG. 2 is a schematic flow chart of S11 in the control method for food cooking based on multi-point detection according to an embodiment of the present disclosure.

FIG. 3 is a schematic flow chart of S12 in the control method for food cooking based on multi-point detection according to an embodiment of the present disclosure.

FIG. 4 is a schematic flow chart of S13 in the control method for food cooking based on multi-point detection according to an embodiment of the present disclosure.

FIG. 5 is a schematic flow chart of S14 in the control method for food cooking based on multi-point detection according to an embodiment of the present disclosure.

FIG. 6 is a schematic flow chart of S15 in the control method for food cooking based on multi-point detection according to an embodiment of the present disclosure.

FIG. 7 is a schematic flow chart of S16 in the control method for food cooking based on multi-point detection according to an embodiment of the present disclosure.

FIG. 8 is a schematic structural diagram of a control system for food cooking based on multi-point detection according to an embodiment of the present disclosure.

FIG. 9 is a schematic structural diagram of an electronic device according to an embodiment of the present disclosure.

### DETAILED DESCRIPTION OF THE EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

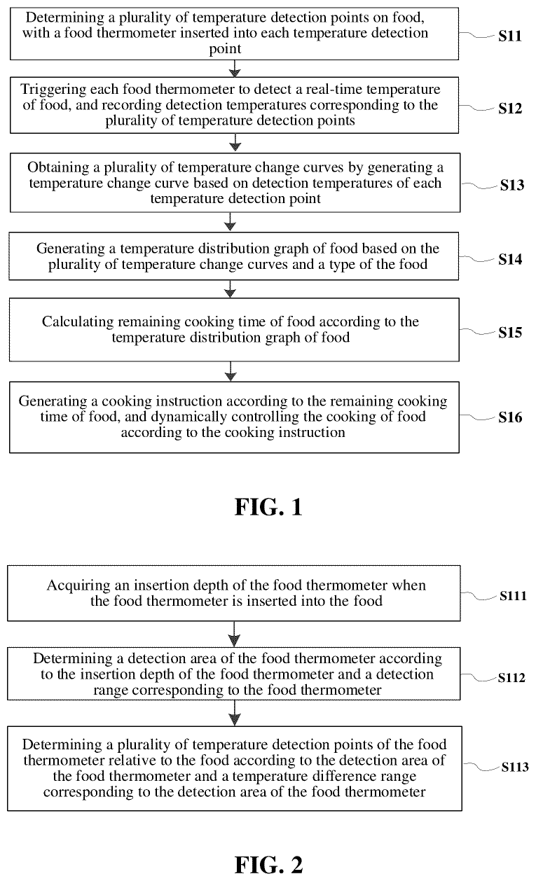

Referring to FIG. 1 to FIG. 9, a control method for food cooking based on multi-point detection is applied to an electronic device. The control method for food cooking based on multi-point detection includes the following steps.
step S11, determining a plurality of temperature detection points on food, with a food thermometer inserted into each temperature detection point;
step S12, triggering each food thermometer to detect a real-time temperature of food, and recording detection temperatures corresponding to the plurality of temperature detection points;
step S13, obtaining a plurality of temperature change curves by generating a temperature change curve based on detection temperatures of each temperature detection point;
step S14, generating a temperature distribution graph of food based on the plurality of temperature change curves and a type of the food;
step S15, calculating remaining cooking time of food according to the temperature distribution graph of food; and
step S16, generating a cooking instruction according to the remaining cooking time of food, and dynamically controlling the cooking of food according to the cooking instruction.

In the embodiment of the present disclosure, through the method in the embodiments of the present disclosure, the plurality of temperature detection points of the food thermometer relative to food are collected. Real-time temperature detecting of food is triggered based on a plurality of temperature detection points, and detection temperatures corresponding to a plurality of temperature detection points are recorded. A temperature change curve of each temperature detection point is generated based on a detection temperature of each temperature detection point. A temperature distribution graph of food is generated based on the plurality of temperature change curves and the type of food. By comprehensively considering the plurality of temperature change curves and the type of food, multi-dimensional control for the plurality of temperature change curves and the type of food is realized, and the accuracy of the temperature distribution graph is ensured.

Further, the remaining cooking time of food is calculated according to the temperature distribution graph of food. A cooking control logic of food is triggered according to the remaining cooking time of food, and a cooking instruction of each part in food is dynamically controlled based on the cooking control logic. The temperature distribution graph of food is fully utilized for cooking control, so that the remaining cooking time of food is calculated, an accuracy of the remaining cooking time of food is ensured, and the temperature control for food and intelligent cooking of food are realized.

Referring to FIG. 2, in step S11, the plurality of temperature detection points of the food thermometer relative to food are determined.

In a specific implementation process of the present disclosure, step S11 may include:
S111, acquiring an insertion depth of the food thermometer when the food thermometer is inserted into the food;
S112, determining a detection area of the food thermometer according to the insertion depth of the food thermometer and a detection range corresponding to the food thermometer; and
S113, determining a plurality of temperature detection points of the food thermometer relative to the food according to the detection area of the food thermometer and a temperature difference range corresponding to the detection area of the food thermometer.

In the embodiments of the present disclosure, when the food thermometer is inserted into the food, the insertion depth of the food thermometer is acquired. The insertion depth of the food thermometer is introduced to facilitate obtain the detection area of the food thermometer.

Further, according to the detection area of the food thermometer and the temperature difference range corresponding to the detection area of the food thermometer, the plurality of temperature detection points of the food thermometer relative to the food are determined.

Therefore, a plurality of temperature detection points of the food thermometer relative to food are determined according to the detection area of the food thermometer and the temperature difference range corresponding to the detection area of the food thermometer. By comprehensively considering the temperature difference range corresponding to the detection area of the food thermometer and the detection area of the food thermometer, the multi-dimensional control of the temperature difference range corresponding to the detection area of the food thermometer and the detection area of the food thermometer is realized, and the reasonability of a plurality of temperature detection points of the food thermometer relative to food is ensured.

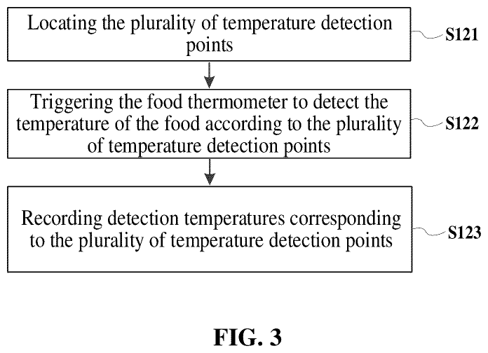

Referring to FIG. 3, in step S12, each food thermometer to detect a real-time temperature of food is triggered, and detection temperatures corresponding to the plurality of temperature detection points are recorded.

In the specific implementation process of the present disclosure, step S12 may include:
S121, locating the plurality of temperature detection points;
S122, triggering the food thermometer to detect the temperature of the food according to the plurality of temperature detection points; and
S123, recording detection temperatures corresponding to the plurality of temperature detection points.

In the embodiments of the present disclosure, a plurality of temperature detection points are located. The detection of the food thermometer to the temperature of the food is triggered according to the plurality of temperature detection points, and the real-time temperature detecting of the food is realized. The detection temperatures corresponding to the plurality of temperature detection points are recorded, so that the detection temperatures corresponding to the plurality of temperature detection points are subsequently processed.

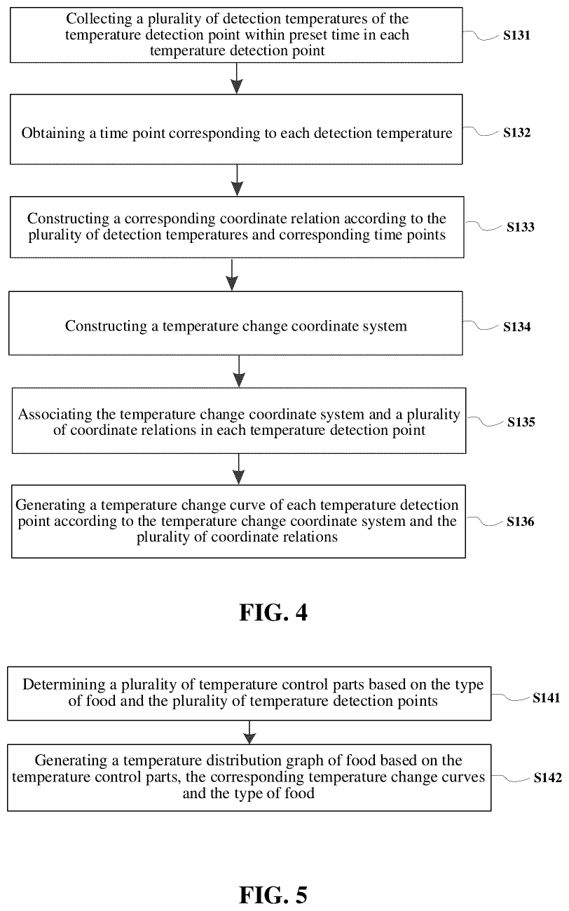

Referring to FIG. 4, in step S13, a plurality of temperature change curves are obtained by generating the temperature change curve based on detection temperatures of each temperature detection point.

In the specific implementation process of the present disclosure, S13 may include:
S131, collecting a plurality of detection temperatures of the temperature detection point within preset time in each temperature detection point;
S132, obtaining a time point corresponding to each detection temperature;
S133, constructing a corresponding coordinate relation according to the plurality of detection temperatures and corresponding time points;
S134, constructing a temperature change coordinate system;
S135, associating the temperature change coordinate system and a plurality of coordinate relations in each temperature detection point; and
S136, generating a temperature change curve of each temperature detection point according to the temperature change coordinate system and the plurality of coordinate relations.

In the embodiments of the present disclosure, the plurality of detection temperatures of the temperature detection point within preset time are collected in each temperature detection point, so that a corresponding coordinate relation is constructed according to the plurality of detection temperatures and the corresponding time points, and subsequent control is performed on the corresponding coordinate relation.

Therefore, the temperature change system is defined, and the temperature change coordinate system is constructed in the temperature change system. In each temperature detection point, a temperature change coordinate system and a plurality of coordinate relations are associated. The temperature change curve of each temperature detection point is defined according to the temperature change coordinate system and a plurality of coordinate relations, and the temperature change coordinate system and a plurality of coordinate relations are compatible to realize multiple interactions of the temperature change coordinate system and a plurality of coordinate relations, so that the accuracy of the temperature change curve of each temperature detection point is ensured.

Refer to FIG. 5, in step S14, the temperature distribution graph of food is generated based on the plurality of temperature change curves and a type of the food.

In the specific implementation process of the present disclosure, step S14 may include:
S141, determining a plurality of temperature control parts based on the type of food and the plurality of temperature detection points; and
S142, generating a temperature distribution graph of food based on the temperature control parts, the corresponding temperature change curves and the type of food.

In the embodiments of the present disclosure, a plurality of temperature detection points of the food thermometer relative to food are collected. Real-time temperature detecting of food is triggered based on a plurality of temperature detection points, and detection temperatures corresponding to a plurality of temperature detection points are recorded. A temperature change curve of each temperature detection point is defined based on a detection temperature of each temperature detection point. A temperature distribution graph of food is constructed based on a plurality of temperature change curves and the type of food. By comprehensively considering the plurality of temperature change curves and the type of food, multi-dimensional control for a plurality of temperature change curves and the type of food is realized, and the accuracy of the temperature distribution graph is ensured.

At this time, a plurality of temperature control parts are constructed based on the type of food and a plurality of temperature detection points. A plurality of temperature control parts and a plurality of temperature change curves are associated, and a plurality of temperature control parts and a plurality of temperature change curves are introduced, so that matching is performed based on the corresponding temperature detection point to match the temperature control part with the corresponding temperature change curve. At this time, the temperature change curve presents a temperature change situation of the temperature control part.

Therefore, a temperature distribution graph of food is constructed based on the temperature control part, the corresponding temperature change curve and the type of food. The temperature distribution graph of food changes in real time with a temperature change of the temperature control part. By comprehensively considering the plurality of temperature change curves and the type of food, multi-dimensional control for a plurality of temperature change curves and the type of food is realized, and the accuracy of the temperature distribution graph is ensured.

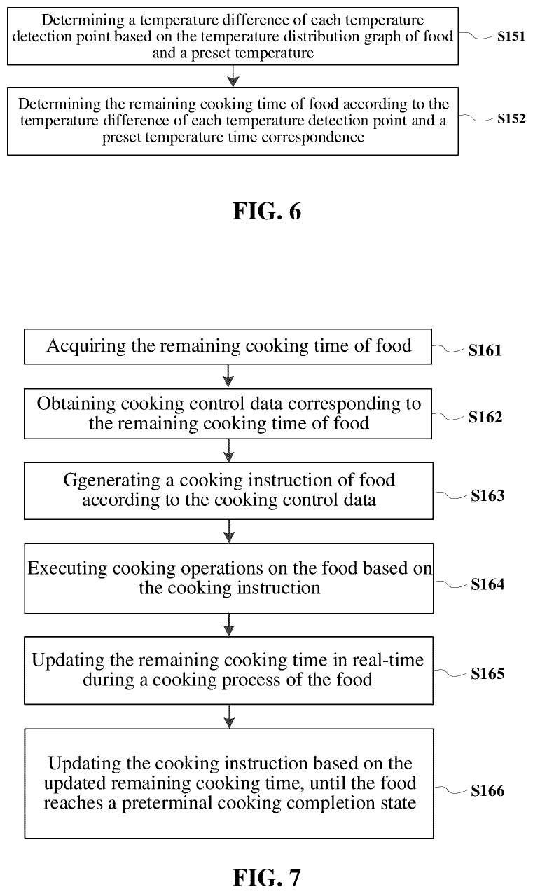

Referring to FIG. 6, in step S15, the remaining cooking time of food is calculated according to the temperature distribution graph of food.

In the specific implementation process of the present disclosure, step S15 may include:
S151, determining a temperature difference of each temperature detection point based on the temperature distribution graph of food and a preset temperature; and
S152, determining the remaining cooking time of food according to the temperature difference of each temperature detection point and a preset temperature time correspondence.

In the embodiments of the present disclosure, the temperature distribution graph of food is obtained, and the temperature distribution graph of food is further processed. At the same time, the temperature difference of each temperature detection point is determined based on the temperature distribution graph of food and the preset temperature time correspondence. By comprehensively considering the temperature distribution graph of food and the preset temperature multi-dimensional control for the temperature distribution graph of food and the preset temperature is realized, and the accuracy of the temperature difference quantity of each temperature detection point is ensured.

By introducing the temperature difference quantity of each temperature detection point, and the remaining cooking time of food can be determined according to the temperature difference quantity of each temperature detection point. By comprehensively considering the temperature difference quantity of each temperature detection point and the preset temperature difference logic, and the accuracy of the remaining cooking time of food is ensured.

In an optional embodiment, the generating a cooking instruction according to the remaining cooking time of food, and dynamically controlling the cooking of food according to the cooking instruction includes: obtaining cooking control data corresponding to the remaining cooking time of food; generating a cooking instruction of food according to the cooking control data; and executing cooking operations on the food based on the cooking instruction.

In addition, the remaining cooking time of each part in food is matched based on the remaining cooking time of food and the real-time temperature of each part in food so as to extend the remaining cooking time of each part in food based on the remaining cooking time of food, thereby introducing the remaining cooking time of each part in food and realizing targeted temperature control of each part.

Referring to FIG. 7, in step S16, the cooking instruction is generated according to the remaining cooking time of food, and the cooking of food is dynamically controlled according to the cooking instruction.

In the specific implementation process of the present disclosure, step S16 may include:
S161, acquiring the remaining cooking time of food;
S162, obtaining cooking control data corresponding to the remaining cooking time of food;
S163, generating a cooking instruction of food according to the cooking control data;
S164, executing cooking operations on the food based on the cooking instruction.

S165, updating the remaining cooking time in real-time during a cooking process of the food; and

S166, updating the cooking instruction based on the updated remaining cooking time, until the food reaches a preterminal cooking completion state.

In the specific implementation process of the present disclosure, the remaining cooking time of food is calculated according to the temperature distribution graph of food. A cooking control logic of food is triggered according to the remaining cooking time of food, and a cooking instruction of each part in food is dynamically controlled based on the cooking control logic. The temperature distribution graph of food is fully utilized for cooking control, so that the remaining cooking time of food is measured and calculated, the accuracy of the remaining cooking time of food is ensured, and the temperature control of the food thermometer for food and intelligent cooking of food are realized.

Therefore, the corresponding cooking control logic of food is matched based on the cooking control information of food, and the cooking control logic of food is triggered. Targeted control is performed on the cooking control logic of food.

Further, the cooking instruction is updated based on further cooking of food in the cooking control logic of food. The dynamic change of food is triggered based on the change of the cooking instruction until the food reaches a well-cooked state. At the same time, the temperature distribution graph of food is fully utilized for cooking control, so that the remaining cooking time of food is measured and calculated, the accuracy of the remaining cooking time of food is ensured, and the temperature control of the food thermometer for food and intelligent cooking of food are realized.

In an optionally embodiment, a base of the food thermometer is connected with a temperature probe (i.e., a data receiving module in an electronic device). The data receiving module can simultaneously receive real-time temperature data from three or more food thermometers, distinguish a slowest heating point, and then estimate the remaining cooking time required to reach a predetermined temperature according to the temperature of the slowest heating point. And the data receiving module can also calculate temperature differences between these three or more food thermometers. If it is detected that any temperature difference exceeds a preset temperature difference threshold (preset temperature difference threshold that will decrease every 1 cm of food depth based on high or low ambient temperature, such as 2-5° C. at high temperatures and 5-10° C. at low temperatures), a warning signal will be issued to a user to remind the user that there may be a risk of being overcooked externally but undercooked internally due to a large temperature difference between an epidermal layer, a superficial layer and a center layer of meat. These can make the roasting process more precise and efficient, thereby ensuring the best taste, flavor and safety achieved every time meat is roasted.

In an embodiment, using three or more food thermometers, to continuously detect real-time temperature data of different parts inside the food. The slowest heating point in the food is distinguished based on the obtained real-time temperature data, and the remaining cooking time required to reach the predetermined temperature is calculated by a heat transfer algorithm according to a current temperature change trend. For example, a current internal temperature of food is 30° C., and an expected temperature for preset internal cooking of the food is 70° C., so the food thermometer will estimate how long it takes to heat from 30° C. to 70° C. according to a change trend of ambient temperature.)

The heat transfer algorithm will dynamically update the remaining cooking time according to the position change of the slowest heating point of food. For example, at the beginning, No. 2 point is the slowest heating point, but after the food is turned or a position of a heat source is changed, the slowest heating point changed to No. 3 point. At this time, the food thermometer may continue to estimate the remaining cooking time according to a temperature change of No. 3 point. Moreover, the heat transfer algorithm model will self-correct through the data of the ambient temperature and the slowest heating point continuously obtained during the cooking process, and continuously analyzes the temperature change trend to improve the accuracy of predicting the remaining cooking time. This can also be applied to an early warning function of recipes. The user can set aside time to make sauces or prepare meals before finishing cooking, so as to enjoy the best doneness and taste of food.

Furthermore, the three or more food thermometers can simultaneously detect the internal temperature of multiple parts of food, and the temperature difference of multi-point temperature data can be calculated. If any temperature difference exceeds a preset temperature difference threshold, the system can immediately provide feedback that cooking parameters needing need to be adjusted, such as a firepower of heating by the heat source, an interval between the meat and the heat source, or the cooking time, to ensure the stability of the cooking process. This helps to ensure that each part reaches an ideal cooking temperature to avoid some parts from being overcooked or undercooked.

In the embodiments of the present disclosure, through the method in the embodiments of the present disclosure, a plurality of temperature detection points of the food thermometer relative to food are collected. Real-time temperature detecting of food is triggered based on a plurality of temperature detection points, and detection temperatures corresponding to a plurality of temperature detection points are recorded. A temperature change curve of each temperature detection point is defined based on a detection temperature of each temperature detection point. A temperature distribution graph of food is constructed based on a plurality of temperature change curves and the type of food. By comprehensively considering the plurality of temperature change curves and the type of food, multi-dimensional control for a plurality of temperature change curves and the type of food is realized, and the accuracy of the temperature distribution graph is ensured.

Further, the remaining cooking time of food is measured and calculated according to the temperature distribution graph of food. The cooking control logic of food is triggered according to the remaining cooking time of food, and a cooking instruction of each part in food is dynamically controlled based on the cooking control logic. The temperature distribution graph of food is fully utilized for cooking control, so that the temperature control of the food thermometer for food and intelligent cooking of food are realized.

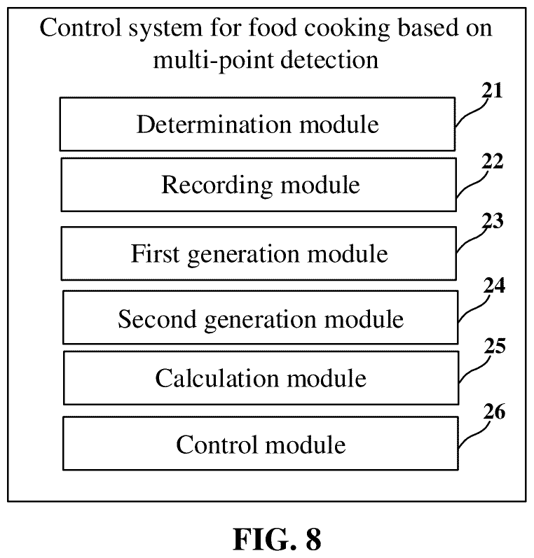

Referring to FIG. 8, FIG. 8 shows a schematic structural diagram of a control system for food cooking based on multi-point detection according to an embodiment of the present disclosure.

As shown in FIG. 8, the control system for food cooking based on multi-point detection is provided. The control system for food cooking based on multi-point detection includes:
a determination module 21, configured to determine a plurality of temperature detection points on food, with a food thermometer inserted into each temperature detection point;
a recording module 22, configured to trigger each food thermometer to detect a real-time temperature of food, and record detection temperatures corresponding to the plurality of temperature detection points;
a first generation module 23, configured to obtain a plurality of temperature change curves by generating a temperature change curve based on detection temperatures of each temperature detection point;
a second generation module 24, configured to generate a temperature distribution graph of food based on the plurality of temperature change curves and a type of the food;
a calculation module 25, configured to calculate remaining cooking time of food according to the temperature distribution graph of food; and
a control module 26, configured to generate a cooking instruction according to the remaining cooking time of food, and dynamically control the cooking of food according to the cooking instruction.

An embodiment of the present disclosure also provides a computer-readable storage medium having stored thereon program codes, which, when executed by a processor, performs the following steps:
determining a plurality of temperature detection points on food, with a food thermometer inserted into each temperature detection point;
triggering each food thermometer to detect a real-time temperature of food, and recording detection temperatures corresponding to the plurality of temperature detection points;
obtaining a plurality of temperature change curves by generating a temperature change curve based on detection temperatures of each temperature detection point;
generating a temperature distribution graph of food based on the plurality of temperature change curves and a type of the food;
calculating remaining cooking time of food according to the temperature distribution graph of food; and
generating a cooking instruction according to the remaining cooking time of food, and dynamically controlling the cooking of food according to the cooking instruction.

In an optional embodiment, when executed by the processor, the program codes implement the step of determining a plurality of temperature detection points on food, which includes:
acquiring an insertion depth of the food thermometer when the food thermometer is inserted into the food;
determining a detection area of the food thermometer according to the insertion depth of the food thermometer and a detection range corresponding to the food thermometer; and
determining a plurality of temperature detection points of the food thermometer relative to the food according to the detection area of the food thermometer and a temperature difference range corresponding to the detection area of the food thermometer.

In an optional embodiment, when executed by the processor, the program codes implement the step of generating a temperature distribution graph of food based on the plurality of temperature change curves and a type of the food, which includes:
determining a plurality of temperature control parts based on the type of food and the plurality of temperature detection points;
matching the plurality of temperature control parts with the plurality of temperature change curve based on the temperature detection points; and
generating a temperature distribution graph of food based on the temperature control parts, the corresponding temperature change curves and the type of food, wherein the temperature distribution graph of food changes in real time with a temperature change of the temperature control part.

In an optional embodiment, when executed by the processor, the program codes implement the step of calculating remaining cooking time of food according to the temperature distribution graph of food, which includes:
determining a temperature difference of each temperature detection point based on the temperature distribution graph of food and a preset temperature; and
determining the remaining cooking time of food according to the temperature difference of each temperature detection point and a preset temperature time correspondence.

In an optional embodiment, when executed by the processor, the program codes implement the step of determining the remaining cooking time of food according to the temperature difference of each temperature detection point and a preset temperature time correspondence, which includes:
determining remaining cooking time for each temperature detection point based on the temperature difference and the preset temperature time correspondence, and obtaining a plurality of the remaining cooking times;
acquiring maximum remaining cooking time from the plurality of the remaining cooking times;
determining the remaining cooking time of food based on the maximum remaining cooking time.

In an optional embodiment, when executed by the processor, the program codes implement the step of generating a cooking instruction according to the remaining cooking time of food, and dynamically controlling the cooking of food according to the cooking instruction, which includes:
obtaining cooking control data corresponding to the remaining cooking time of food;
generating a cooking instruction of food according to the cooking control data; and
executing cooking operations on the food based on the cooking instruction.

In an optional embodiment, when executed by the processor, the program codes further implement the steps:
updating the remaining cooking time in real-time during a cooking process of the food; and
updating the cooking instruction based on the updated remaining cooking time, until the food reaches a preterminal cooking completion state.

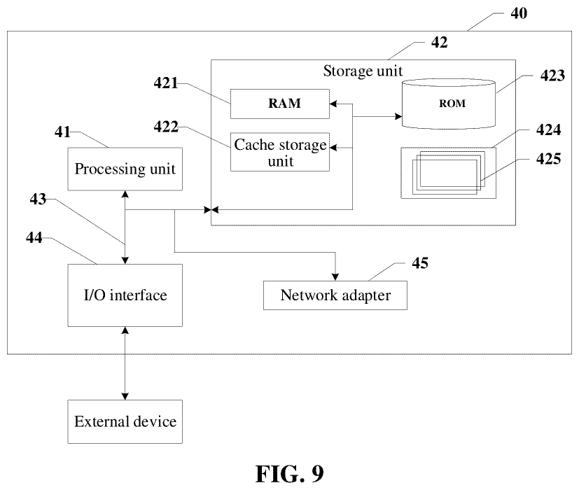

Referring to FIG. 9, an electronic device 40 according to such embodiment of the present disclosure is described with reference to FIG. 9. The electronic device 40 shown in FIG. 9 is merely an example, and should not impose any limitation on the functions and scope of use of the embodiments of the present disclosure.

As shown in FIG. 9, the electronic device 40 is embodied in the form of a general computing device. The components of the electronic device 40 may include, but are not limited to, the at least one processing unit 41, the at least one storage unit 42, and a bus 43 connecting different system components (including the storage unit 42 and the processing unit 41).

Wherein, the storage unit stores program code that can be executed by the processing unit 41 so that the processing unit 41 performs the steps according to various exemplary embodiments of the present disclosure described in the “Embodiment Method” of the present specification.

The storage unit 42 may include a readable medium in the form of a volatile storage unit, such as a random-access memory (RAM) 421 and/or a cache storage unit 422, and may further include a read-only storage unit (ROM) 423.

The storage unit 42 may also include a program/tool 424 having a set (at least one) of program modules 425 including, but not limited to, an operating system, one or more application programs, other program modules, and program data, which may include implementations of a network environment in each or some combination of these examples.

The bus 43 may represent one or more of several types of bus structures, including a storage unit bus or storage unit controller, a peripheral bus, a graphics acceleration port, a processing unit, or a local bus using any of a variety of bus structures.

The electronic device 40 may also communicate with one or more external devices (such as keyboards, pointing devices and Bluetooth devices), and may also communicate with one or more devices that enable a user to interact with the electronic device 40, and/or with any device (such as a router and a modem) that enables the electronic device 40 to communicate with one or more other computing devices. Such communication may be performed by an input/output (I/O) interface 44. Further, the electronic device 40 may also communicate with one or more networks (such as a local area network (LAN), a wide area network (WAN), and/or a public network, such as the Internet) through a network adapter 45. As shown in FIG. 9, the network adapter 45 communicates with other modules of the electronic device 40 through the bus 43. It should be understood that although not shown in FIG. 9, other hardware and/or software modules may be used in combined with the electronic device 40, including, but not limited to, microcode, device drivers, redundant processing units, external disk drive arrays, RAID systems, tape drives, and data backup planning systems.

From the above description of the embodiments, it will be readily understood by those skilled in the art that the example embodiments described herein may be implemented by software, or may be implemented by software in combination with necessary hardware. Therefore, the technical solutions according to the embodiments of the present disclosure can be embodied in the form of a software product. The software product can be stored in a non-volatile storage medium (which may be a CD-ROM, a USB flash drive or a mobile hard disk) or on the network, and includes several instructions to make one computing device (which may be a personal computer, a server, a terminal device or a network device) execute the method according to the embodiments of the present disclosure.

A person of ordinary skill in the art may understand that all or some of the steps of various methods in the embodiments may be implemented by a program instructing related hardware. The program may be stored in a computer readable storage medium. The storage medium may include a read-only memory (ROM), a random-access memory (RAM), a magnetic disk or an optical disk. Moreover, computer program instructions are stored. When the computer program instructions are executed by the computer, the computer executes the method according to the above.

Moreover, the control method and system for food cooking based on multi-point detection provided by the embodiments of the present disclosure are described in detail above. In this specification, specific examples are used to describe the principle and implementations of the present disclosure. The description of the embodiments is only intended to help understand the method and core idea of the present disclosure, and those skilled in the art may make modifications based on the idea of the present disclosure with respect to the specific implementations and the application scope. Therefore, the content of this specification shall not be construed as limitations on the embodiments of this application.

What is claimed is:

1. A control method for food cooking based on multi-point detection applicable in an electronic device, comprising:
determining a plurality of temperature detection points on food, with a food thermometer inserted into each temperature detection point;
triggering each food thermometer to detect a real-time temperature of food, and recording detection temperatures corresponding to the plurality of temperature detection points;
obtaining a plurality of temperature change curves by generating a temperature change curve based on detection temperatures of each temperature detection point;
generating a temperature distribution graph of food based on the plurality of temperature change curves and a type of the food;
calculating remaining cooking time of food according to the temperature distribution graph of food; and
generating a cooking instruction according to the remaining cooking time of food, and dynamically controlling the cooking of food according to the cooking instruction.

2. The control method for food cooking based on multi-point detection according to claim 1, wherein the step of determining a plurality of temperature detection points on food comprises:
acquiring an insertion depth of the food thermometer when the food thermometer is inserted into the food;
determining a detection area of the food thermometer according to the insertion depth of the food thermometer and a detection range corresponding to the food thermometer; and
determining a plurality of temperature detection points of the food thermometer relative to the food according to the detection area of the food thermometer and a temperature difference range corresponding to the detection area of the food thermometer.

3. The control method for food cooking based on multi-point detection according to claim 2,
wherein the step of generating a temperature distribution graph of food based on the plurality of temperature change curves and a type of the food comprises:
determining a plurality of temperature control parts based on the type of food and the plurality of temperature detection points;
matching the plurality of temperature control parts with the plurality of temperature change curve based on the temperature detection points; and
generating a temperature distribution graph of food based on the temperature control parts, the corresponding temperature change curves and the type of food, wherein the temperature distribution graph of food changes in real time with a temperature change of the temperature control part.

4. The control method for food cooking based on multi-point detection according to claim 3, wherein the step of calculating remaining cooking time of food according to the temperature distribution graph of food comprises:
determining a temperature difference of each temperature detection point based on the temperature distribution graph of food and a preset temperature; and
determining the remaining cooking time of food according to the temperature difference of each temperature detection point and a preset temperature time correspondence.

5. The control method for food cooking based on multi-point detection according to claim 4, wherein the step of determining the remaining cooking time of food according to the temperature difference of each temperature detection point and a preset temperature time correspondence comprises:
determining remaining cooking time for each temperature detection point based on the temperature difference and the preset temperature time correspondence, and obtaining a plurality of the remaining cooking times;
acquiring maximum remaining cooking time from the plurality of the remaining cooking times;
determining the remaining cooking time of food based on the maximum remaining cooking time.

6. The control method for food cooking based on multi-point detection according to claim 1, wherein the step of generating a cooking instruction according to the remaining cooking time of food, and dynamically controlling the cooking of food according to the cooking instruction comprises:
obtaining cooking control data corresponding to the remaining cooking time of food;
generating a cooking instruction of food according to the cooking control data; and
executing cooking operations on the food based on the cooking instruction.

7. The control method for food cooking based on multi-point detection according to claim 6, further comprising:
updating the remaining cooking time in real-time during a cooking process of the food; and
updating the cooking instruction based on the updated remaining cooking time, until the food reaches a preterminal cooking completion state.

8. An electronic device, comprising:
at least one processing unit; and
at least one storage unit storing program codes which, wherein the at least one processor, when executing the program codes, implements the following steps:
determining a plurality of temperature detection points on food, with a food thermometer inserted into each temperature detection point;
triggering each food thermometer to detect a real-time temperature of food, and recording detection temperatures corresponding to the plurality of temperature detection points;
obtaining a plurality of temperature change curves by generating a temperature change curve based on detection temperatures of each temperature detection point;
generating a temperature distribution graph of food based on the plurality of temperature change curves and a type of the food;
calculating remaining cooking time of food according to the temperature distribution graph of food; and
generating a cooking instruction according to the remaining cooking time of food, and dynamically controlling the cooking of food according to the cooking instruction.

9. The electronic device according to claim 8, wherein the at least one processor, when executing the program codes, implements the step of determining a plurality of temperature detection points on food, which comprises:
acquiring an insertion depth of the food thermometer when the food thermometer is inserted into the food;
determining a detection area of the food thermometer according to the insertion depth of the food thermometer and a detection range corresponding to the food thermometer; and
determining a plurality of temperature detection points of the food thermometer relative to the food according to the detection area of the food thermometer and a temperature difference range corresponding to the detection area of the food thermometer.

10. The electronic device according to claim 9, wherein the at least one processor, when executing the program codes, implements the step of generating a temperature distribution graph of food based on the plurality of temperature change curves and a type of the food, which comprises:
determining a plurality of temperature control parts based on the type of food and the plurality of temperature detection points;
matching the plurality of temperature control parts with the plurality of temperature change curve based on the temperature detection points; and
generating a temperature distribution graph of food based on the temperature control parts, the corresponding temperature change curves and the type of food, wherein the temperature distribution graph of food changes in real time with a temperature change of the temperature control part.

11. The electronic device according to claim 10, wherein the at least one processor, when executing the program codes, implements the step of calculating remaining cooking time of food according to the temperature distribution graph of food, which comprises:
determining a temperature difference of each temperature detection point based on the temperature distribution graph of food and a preset temperature; and
determining the remaining cooking time of food according to the temperature difference of each temperature detection point and a preset temperature time correspondence.

12. The electronic device according to claim 11, wherein the at least one processor, when executing the program codes, implements the step of determining the remaining cooking time of food according to the temperature difference of each temperature detection point and a preset temperature time correspondence, which comprises:
determining remaining cooking time for each temperature detection point based on the temperature difference and the preset temperature time correspondence, and obtaining a plurality of the remaining cooking times;
acquiring maximum remaining cooking time from the plurality of the remaining cooking times;
determining the remaining cooking time of food based on the maximum remaining cooking time.

13. The electronic device according to claim 1, wherein the at least one processor, when executing the program codes, implements the step of generating a cooking instruction according to the remaining cooking time of food, and dynamically controlling the cooking of food according to the cooking instruction, which comprises:
obtaining cooking control data corresponding to the remaining cooking time of food;
generating a cooking instruction of food according to the cooking control data; and
executing cooking operations on the food based on the cooking instruction.

14. The electronic device according to claim 13, wherein the at least one processor, when executing the program codes, further implements the following steps:
updating the remaining cooking time in real-time during a cooking process of the food; and
updating the cooking instruction based on the updated remaining cooking time, until the food reaches a preterminal cooking completion state.

15. A non-transitory storage medium having stored thereon instructions that, when executed by a processor of water treatment equipment, causes the processor to perform a control method for food cooking based on multi-point detection, the method comprising:
determining a plurality of temperature detection points on food, with a food thermometer inserted into each temperature detection point;
triggering each food thermometer to detect a real-time temperature of food, and recording detection temperatures corresponding to the plurality of temperature detection points;
obtaining a plurality of temperature change curves by generating a temperature change curve based on detection temperatures of each temperature detection point;
generating a temperature distribution graph of food based on the plurality of temperature change curves and a type of the food;
calculating remaining cooking time of food according to the temperature distribution graph of food; and
generating a cooking instruction according to the remaining cooking time of food, and dynamically controlling the cooking of food according to the cooking instruction.

16. The non-transitory storage medium according to claim 15, wherein when executed by the processor, the program codes implement the step of determining a plurality of temperature detection points on food, which comprises:
acquiring an insertion depth of the food thermometer when the food thermometer is inserted into the food;
determining a detection area of the food thermometer according to the insertion depth of the food thermometer and a detection range corresponding to the food thermometer; and
determining a plurality of temperature detection points of the food thermometer relative to the food according to the detection area of the food thermometer and a temperature difference range corresponding to the detection area of the food thermometer.

17. The non-transitory storage medium according to claim 16, wherein when executed by the processor, the program codes implement the step of generating a temperature distribution graph of food based on the plurality of temperature change curves and a type of the food, which comprises:
determining a plurality of temperature control parts based on the type of food and the plurality of temperature detection points;
matching the plurality of temperature control parts with the plurality of temperature change curve based on the temperature detection points; and
generating a temperature distribution graph of food based on the temperature control parts, the corresponding temperature change curves and the type of food, wherein the temperature distribution graph of food changes in real time with a temperature change of the temperature control part.

18. The non-transitory storage medium according to claim 17, wherein when executed by the processor, the program codes implement the step of calculating remaining cooking time of food according to the temperature distribution graph of food, which comprises:
determining a temperature difference of each temperature detection point based on the temperature distribution graph of food and a preset temperature; and
determining the remaining cooking time of food according to the temperature difference of each temperature detection point and a preset temperature time correspondence.

19. The non-transitory storage medium according to claim 18, wherein when executed by the processor, the program codes implement the step of determining the remaining cooking time of food according to the temperature difference of each temperature detection point and a preset temperature time correspondence, which comprises:
determining remaining cooking time for each temperature detection point based on the temperature difference and the preset temperature time correspondence, and obtaining a plurality of the remaining cooking times;
acquiring maximum remaining cooking time from the plurality of the remaining cooking times;
determining the remaining cooking time of food based on the maximum remaining cooking time.

20. The non-transitory storage medium according to claim 15, wherein when executed by the processor, the program codes implement the step of generating a cooking instruction according to the remaining cooking time of food, and dynamically controlling the cooking of food according to the cooking instruction, which comprises:
obtaining cooking control data corresponding to the remaining cooking time of food;
generating a cooking instruction of food according to the cooking control data; and
executing cooking operations on the food based on the cooking instruction.
